(19) United States
(12) Patent Application Publication
(10) Pub. No.: US 2023/0197966 A1
(43) Pub. Date: Jun. 22, 2023

(54) LITHIUM-ION BATTERY ANODE MATERIAL AND METHODS OF MAKING THE SAME

(71) Applicant: NOHMS Technologies, Inc., Rochester, NY (US)

(72) Inventors: Surya S. Moganty, Henrietta, NY (US); Rutvik Vaidya, Rochester, NY (US); Xiaojing Zhu, Rochester, NY (US); Kevin R. Brown, Jr., Rochester, NY (US)

(21) Appl. No.: 18/083,196

(22) Filed: Dec. 16, 2022

Related U.S. Application Data
(60) Provisional application No. 63/290,371, filed on Dec. 16, 2021.

(51) Int. Cl. H01M 4/62; H01M 4/583; H01M 4/38; H01M 4/04

(52) U.S. Cl. CPC H01M 4/623; H01M 4/386; H01M 4/0471; H01M 4/583; H01M 2004/027

(57) ABSTRACT

An anode including a plurality of active material particles, a first polymer binder that undergoes a cyclization reaction when heated and a second polymer binder, wherein the first polymer binder is a different type of polymer binder from the first polymer binder; an electrochemical energy storage device containing the anode; and a method of making the anode are disclosed.

### CROSS REFERENCE

This application claims the benefit of the filing date of U.S. Provisional Pat. Application No. 63/290,371, filed Dec. 16, 2021, which is hereby incorporated by reference in its entirety.

### FIELD

The present disclosure relates to anode materials for improving conductivity, specific capacity, and cycle life stability, and methods for producing high-capacity anode materials suitable for use in electrochemical energy storage devices. More specifically, the present disclosure relates to the use of two or more polymer binders in a Li-ion battery anode material, such as the combination of polyacrylonitrile (PAN) and poly(vinylidene fluoride) (PVDF); PAN, PVDF and Poly Imide (PI); and other combinations of polymer binders.

### BACKGROUND

Lithium ion (Li-ion) batteries are heavily used in consumer electronics, electric vehicles (EVs), energy storage systems (ESS) and smart grids. The energy density of Li-ion batteries is dependent at least in part on the anode and cathode materials used. Optimizing processing and manufacturing of Li-ion batteries has allowed for a 4-5% improvement in the energy density of Li-ion batteries each year, but these incremental improvements are not sufficient for reaching energy density targets of next-generation technologies. To reach such targets, advancements in electrode materials will be required, such as incorporating high energy-density active materials into electrodes. Recent research has focused primarily on developing high energy cathodes, with only limited research dedicated to the development of anode materials.

Recently, silicon has emerged as one of the most attractive high energy anode materials for Li-ion batteries. Silicon’s low working voltage and high theoretical specific capacity of 3579 mAh/g is nearly ten times that of conventional graphite, thus resulting in increased interest. U.S. Pat. Nos. 10,573,884 and 10,707,481 describe anode compositions including silicon active material particles and a single polymer binder such as polyacrylonitrile (PAN). The ’884 and ’481 patents describe PAN as the sole polymer binder present in the anode material, and further describe how the PAN polymer binder can be cyclized.

The technique of adding graphite to pure silicon-based anodes is commonly employed to add a structural matrix around silicon particles, and to allow for higher conductivity within the anode. In silicon dominant anode designs with less than 25 wt. % graphite, PAN binder wraps around the silicon particles to allow for controlled fragmentation and improve the anode conductivity, and the graphite particles act as a structural matrix. In anode designs with higher graphite content (i.e., more than 25 wt. %), the PAN binder does not efficiently bind both silicon and graphite particles, and the non-binded graphite particles cause capacity fade in cells. Accordingly, a need exists for improved anode materials for Li-ion batteries.

### SUMMARY

In accordance with an aspect of the present disclosure, there is provided an anode configured for use in an electrochemical energy storage device, the anode including a plurality of active material particles; a first cyclized polymer binder; and a second polymer binder, wherein the first polymer binder is a different type of polymer binder from the first polymer binder.

In accordance with another aspect of the present disclosure, there is provided an electrochemical energy storage device including an anode including a plurality of active material particles, a first cyclized polymer binder, and a second polymer binder, wherein the first polymer binder is a different type of polymer binder from the second polymer binder; a cathode; and an electrolyte including at least one lithium salt.

In accordance with another aspect of the present disclosure, there is provided method of making an anode for use in an electrochemical energy storage device, the method including:
a) mixing together a plurality of active material particles, a first polymer binder that undergoes a cyclization reaction when heated and a second polymer binder (of a different type than the first polymer binder) to form a mixture;
b) coating the mixture onto a current collector to form a coated current collector; and
c) subjecting the coated current collector to a temperature treatment.

These and other aspects of the present disclosure will become apparent upon a review of the following detailed description and the claims appended thereto.

### BRIEF DESCRIPTION OF THE DRAWINGS

FIG. 1 is a flow diagram illustrating a method of making an anode material according to various embodiments described herein;

FIG. 2A is a picture showing an image of an anode electrode prepared with PVDF as a single polymer binder from the full pouch cell, after completion lithiation, substantial expansion was observed and delamination of coating and FIG. 2B is a picture of the anode electrode showing substantial expansion after completion lithiation;

FIG. 3A is a picture showing an image of an anode coating material prepared with two different types of polymer binder (i.e., cyclized PAN binder and PVDF binder), FIG. 3B is a picture showing the length dimension of the anode coating, and FIG. 3C is a picture showing the thickness dimension of the anode coating.

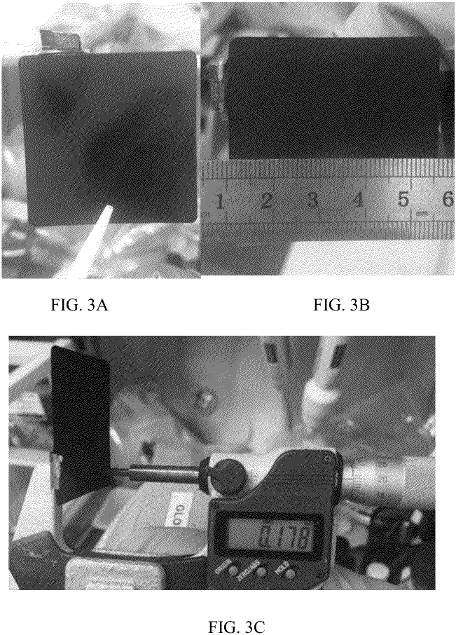

### DETAILED DESCRIPTION

Described herein are various embodiments of Li-battery anode materials and methods of making the same, wherein the anode materials include at least a first polymer binder that undergoes a cyclization reaction when heated and a second polymer binder.

In some embodiments, an anode configured for use in an electrochemical energy storage device is described. The anode includes a plurality of active material particles, a first polymer binder and a second polymer binder. The first polymer binder is a different type of polymer binder from the second polymer binder. One of the two different types of polymer binder must undergo a cyclization reaction when heated. In some embodiments the first polymer binder is polyacrylonitrile (PAN) (including, e.g., cyclized PAN) and the second polymer binder is poly(vinylidene fluoride) (PVDF).

In some embodiments, an electrochemical energy storage device is described, the electrochemical energy storage device including an anode, a cathode and an electrolyte. The anode includes a plurality of active material particles, a first polymer binder and a second polymer binder. The first polymer binder is a different type of polymer binder from the second polymer binder. One of the two different types of polymer binder must undergo a cyclization reaction when heated. In some embodiments the first polymer binder is PAN (including, e.g., cyclized PAN) and the second polymer binder is PVDF.

In some embodiments, a method of making anode active material is described, the method includes the steps of mixing together a plurality of active material particles, a first polymer binder that undergoes a cyclization reaction when heated and a second polymer binder to form a mixture; coating the mixture onto a current collector, e.g., copper, to form a coated current collector; and subjecting the coated current collector to a temperature treatment. In some embodiments the first polymer binder is PAN (including, e.g., cyclized PAN) and the second polymer binder is PVDF.

Described herein are various embodiments of an anode material including active material particles (e.g., silicon and graphite particles), a first polymer binder that undergoes a cyclization reaction when heated and a second polymer binder. The use of two types of binders can help to control the expansion of the active silicon particles, allow sufficient conductivity in the anode, and bind together the active graphite particles. Consequently, use of a dual binder system in anode material can improve the cycle life of the battery in which the anode material is employed.

The anode material includes at least a first polymer binder that undergoes a cyclization reaction when heated and a second polymer binder, wherein the first polymer binder is a different type of polymer binder from the second polymer binder. Polymer binders with different functional groups, such as —COOR, —OH, —NH₂, —C═N, and —C—F are defined as different type of binders. Binders can also be differentiated based on their ability to bond with Si active materials. For example, C—F bond is not reactive and hence will not bind with Si particles, but reactive functional groups will interact with Si particles by forming hydrogen bonds, ion-dipole bonds, and the like. The specific type of polymer binder used for the first and second polymer binder is generally not limited, nor is the specific combination of polymer binders used for the first and second polymer binders. Exemplary polymer binders that can be used for either the first or second polymer binder include, but are not limited to, polyacrylonitrile (PAN), poly(vinylidene fluoride) (PVDF), polyacrylic acid (PAA), polyvinyl alcohol (PVA), polyimide (PI), styrene-butadiene rubber (SBR), and carboxymethyl cellulose (CMC).

In some embodiments, the first polymer binder is polyacrylonitrile (PAN). In some embodiments wherein PAN is used as the first polymer binder component of the anode material, the anode material may be prepared and/or treated in such a way that the PAN becomes cyclized PAN. That is to say, in the final form of the anode material, the first polymer binder is cyclized PAN. Any method of preparing and/or treating the anode material to cyclize the PAN may be used. In some embodiments, the anode material is heated within a range of from about 200° C. to about 600° C. to cyclize the PAN polymer binder component. In some embodiments, the anode material is heated to a temperature above 230° C. to carry out this cyclization. In some embodiments, a temperature range of between 240° C. and 400° C. is used.

In some embodiments where the first polymer binder is PAN, the second polymer binder is PVDF. The combination of PAN and PVDF as the polymer binders has been found to be an especially effective mechanism for controlling the expansion of silicon particles, allowing sufficient conductivity in the anode, and binding together the graphite particles.

The total amount of polymer binder used in the anode material is generally not limited. In some embodiments, the total amount of polymer binder (e.g., the combination of the first polymer binder and the second polymer binder) is in the range of from about 5 to about 40 wt. % of the anode material. The amount of each specific polymer binder is also generally not limited. In some embodiments, the anode material is from about 5 wt. % to about 30 wt. % of the first polymer binder and from about 1 wt. % to about 20 wt. % of the second polymer binder. The amount of first polymer binder and second polymer binder in the anode material can also be selected based on a ratio of first polymer binder to second polymer binder. The ratio of first polymer binder to second polymer binder is also generally not limited. In some embodiments, the ratio of first polymer binder to second polymer binder in the anode material is from about 1:1 to about 4:1.

In some embodiments, the anode material may include any number of additional polymer binders beyond the first and second polymer binders. For example, in some embodiments, the anode material includes a third polymer binder. The additional polymer binders can be selected from the same list of polymer binders provided previously, provided that the additional polymer binders are a different type of polymer binder from the polymer binder used for the first polymer binder and the second polymer binder.

The anode material described herein further includes a plurality of active material particles. Any suitable active material particles can be used, though in some embodiments, the active material particles include silicon particles and graphite particles. Any type of active material particle including silicon can be used for the silicon particle component, such as bare silicon particles, Si-composite particles, or any combination thereof. In some embodiments, at least some, if not all, of the silicon particles provided in the anode material are Si-composite particles. When all silicon particles present in the anode are Si-composite particles, the Si-composite particles may all be of the same type (e.g., all Si-composite particles are Si-carbon particles), or the Si-composite particles may be made up of two or more different types of Si-composite particles (e.g., some Si-composite particles are Si-carbon particles while other Si-composite particles are silicon oxide particles). In embodiments where the silicon particles include both Si-composite particles and non-Si-composite particles, the Si-composite particles can be all of one type or can be two or more types of Si-composite particles. The non-Si-composite particles may be any suitable type or types of active material that is not an Si-composite material. In some embodiments, the non-Si-composite particles included in the anode material are bare silicon particles.

Any suitable Si-composite material can be used for the Si-composite particles included in the anode material described herein. In some embodiments, the Si-composite particles are Si-carbon composite materials, such as carbon-coated Si particles. In some embodiments, silicon oxides (SiOₓ) are used. The Si-composite can also be an alloy of Si with inert metals or non-metals, such as silicon metal alloys. Other examples of Si-composite materials that may be used in the embodiments described herein include graphene-silicon composites, graphene oxide-silicon-carbon nanotubes, silicon-polypyroles, and composites of nano and micron sized silicon particles. As described previously, any combination of Si-composite materials can be used in the anode material, or just a single Si-composite material can be used.

In some embodiments, the total active material particle content of the anode material (i.e., combination of silicon particles and graphite particles), is generally from about 30 wt. % to about 90 wt. % of the anode material, such as about 50 wt. % to about 80 wt. %. The silicon particles may be from about 30 wt. % to about 80 wt. % of the anode material, and the graphite particles may be from about 10 wt. % to about 60 wt. % of the anode material. In some embodiments, all active material particles present in the anode material can have a size in the range of from about 1 nm to about 100 µm.

In embodiments where the first binder is PAN and the second binder is PVDF, the weak van der Walls forces between PVDF and the graphite particles can dissociate and have a high degree of reversibility, whereas hydrogen-bonding and ion-dipole type interactions with reactive functional groups that are present in PAN are necessary to improve the performance of silicon-based anodes. As such, the amount of first polymer and second polymer used in the anode generally depends on the silicon and graphite content of the anode material.

Additional components that may be included in the anode material include conductive carbon nanoparticles and acid binders. When conductive carbon nanoparticles are included in the anode material, they may be present in a range of from about 0.1 wt. % to about 5 wt. %. Any suitable conductive nanoparticles can be used, including, but not limited to, VGCF, carbon black, and carbon nanotubes. The addition of such conductive carbon nanoparticles can enhance the conductivity of the anode material. Acid binders that may be included in the anode slurry used to make the anode material can include, for example, oxalic acid, citric acid, maleic acid, tartaric acid, and 1,2,3,4-butanetetracarboxylic acid. Acid binders can be used to improve dispersion and adhesion properties. When used in the anode material, the acid binder may be present in a range from about 0.01 wt. % to about 2 wt. %.

Beyond the previously described active material particles, first and second polymer binders, conductive carbon nanoparticles and acid binders, the anode material described herein may include any other materials suitable for use in an anode material. Other materials that may be present in the anode material include, but are not limited to, sulfur, hard-carbon, graphite, tin, and germanium particles. When present in the anode material, these materials may be present in a range of about 0.1 wt. % to about 60 wt. % of the anode composite material.

The anode material described herein can be incorporated into an electrochemical energy storage device. The electrochemical energy storage device generally includes the anode material as described herein, a cathode, and an electrolyte. In some embodiments, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

Suitable cathodes for use in the electrochemical energy storage device include those such as, but not limited to, a lithium metal oxide, spinel, olivine, carbon-coated olivine, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCo_{y}Met_{z}O₂, A_{n′},B₂(XO₄)₃, vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, and 0≤z≤0.5 and 0≤n¹≤0.3. According to some embodiments, the spinel is a spinel manganese oxide with the formula of Li₁+ₓMn_{2-z}Met‴_{y}O₄-ₘX′ₙ, wherein Met‴ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of LiFePO₄, or Li₁₊ₓFe_{1z}Met″_{y}PO₄₋ₘX′ₙ, wherein Met″ is Al, Mg, Ti, B, Ga, Si, Ni, Mn or Co; X′ is S or F; and wherein 0≤x≤0.3, 0 0≤y≤0.5, 0≤z≤0.5, 0≤m≤0.5 and 0≤n≤0.5.

In some embodiments, the electrolyte component of the electrochemical energy storage device includes an aprotic organic solvent system, a metal salt, and at least one additive.

In some embodiments, the aprotic organic solvent system component of the electrolyte is selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 20 wt. % to 90 wt. %.

In some embodiments, the metal salt component of the electrolyte is a lithium salt in a range of from 10 wt. % to 30 wt. %. A variety of lithium salts may be used, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)_{2]}; Li[BF₂C₂O₄]; Li₂[B₁₂Z₁₂-ⱼHⱼ]; Li₂[B₁₀X₁₀_{-j′}H_{j′}]; or a mixture of any two or more thereof, wherein Z is independent at each occurrence a halogen, j is an integer from 0 to 12 and j′ is an integer from 1 to 10.

In some embodiments, the at least one additive is a compound containing at least one unsaturated carbon-carbon bond, carboxylic acid anhydrides, sulfur-containing compounds, phosphorus-containing compounds, boron-containing compounds, silicon-containing compounds, or mixtures thereof in a range of from 0.1 wt. % to 10 wt. %.

In some embodiments where the electrochemical energy storage device is a secondary battery, the secondary battery may further include a separator separating the positive and negative electrode. The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

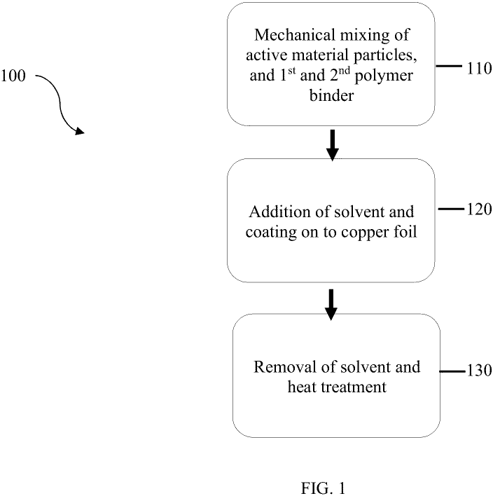

With reference to FIG. 1, a flow diagram showing an embodiment of a method 100 for preparing the anode material described herein includes step 110 of mixing together active material particles, a first polymer binder that undergoes a cyclization reaction when heated, and a second polymer binder to form a mixture, a step 120 of adding a solvent to the mixture and coating the mixture on a copper current collector, and a step 130 of removing the solvent form the coating and subjecting the coated current collector to a heat treatment.

With respect to step 110, active material particles, the first polymer binder and the second polymer binder are mixed together to form a mixture. Any manner of mixing together these materials can be used, though in some embodiments, mechanical mixing is used. For example, the components can be mixed together by ball milling the solids at low rpm. Typically, the polymer binders are mixed with solvent before adding the solids to the slurry and dispersed using high shear mixing.

In step 120, a solvent is added to the mixture to disperse the active material particles. Any suitable solvent can be used at any suitable amount. In some embodiments, the solvent is anhydrous NMP. Other suitable solvents include, but are not limited to, N,N-dimethylformamide (DMF), dimethyl sulfone (DMSO₂), dimethyl sulfoxide (DMSO), ethylene carbonate (EC), and propylene carbonate (PC). The solvent can be mixed with the mixture of silicon composite particles and polymer binder for any suitable amount of time, such as about 12 hours. Solvent mixing can be done using high shear centrifugal mixing or using a stir-bar in a glass vial.

Step 120 further includes coating the slurry mixture on a current collector. The material of the current collector can be any suitable current collector material, such as copper. The coating step can be carried out using any suitable techniques and equipment, such as a benchtop doctor-blade coater.

In step 130, the solvent is removed from the material coated on the current collector and then the coated current collector is subjected to a heat treatment. While this step is described as two separate actions, it may be possible in some embodiments to remove the solvent from the coating as part of the heat treatment step. When solvent is removed first, the solvent can be removed by heating the coating at a temperature generally below the temperature used in the subsequent heat treatment step but above the temperature needed to remove the solvent from the coating. For example, in some embodiments, the solvent is removed from the coating by first subjecting the coated current collector to a temperature of about 60° C. (such as in a convection oven) to evaporate off the solvent.

Following solvent removal, step 130 continues with the coated current collector being subjected to a heat treatment. The heat treatment may include heating the coated current collector in an inert atmosphere to a temperature in the range of from about 200° C. to about 600° C., such as in an inert argon gas atmosphere at about 330° C. The temperature can be in the range of from about 240° C. to about 400° C. In embodiments where the first or second polymer binder is PAN, the heat treatment step may be aimed at cyclizing the PAN component. Cyclization of PAN is the process when the nitrile bond (C≡N) gets converted to a double bond (C═N) due to crosslinking of PAN molecules. This process yields ladder polymer chains of PAN fiber that are elastic but mechanically robust, thus allowing for controlled fragmentation of silicon particles.

From the foregoing, it will be appreciated that specific embodiments of the invention have been described herein for purposes of illustration, but that various modifications may be made without deviating from the scope of the disclosure. The disclosure will be further illustrated with reference to the following specific examples. It is understood that these examples are given by way of illustration and are not meant to limit the disclosure or the claims to follow.

### Example 1

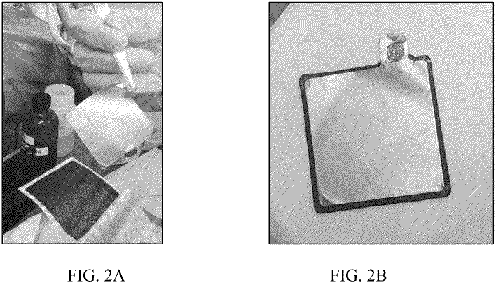

Silicon composite material was mixed with 150,000 MW (150 K) PAN and PVDF polymer binders by ball milling the solids at low rpm. Anhydrous NMP was used as solvent to disperse the conductive carbon additive C65 using centrifugal mixing before adding the silicon/PAN solid mixture to the dispersion. The slurry was mixed overnight, and a benchtop doctor-blade coater was used to slurry the slurry on to copper current collectors to get electrodes with > 3 mg/cm² solid loadings. The electrodes were dried at 60° C. to remove NMP solvent. Except for the comparative electrodes that contain the single PVDF binder shown in FIG. 2, all other electrodes containing PAN binder were then heat treated in an inert argon atmosphere at 330° C. During the heat treatment process the PAN binder undergoes a cyclization process to convert the suspended nitrile (triple bonds) to conjugated nitrile groups. To exhibit the effectiveness of the cyclized PAN binder in providing both mechanical integrity and conductivity, full pouch cells were tested against NMC 811 cathode (4 mAh/cm²). Table 1 compares the full cell data for anode compositions shown in Table 1. The combination of two polymer binders (PAN and PVDF) provide better performance compared with anodes containing either PAN or PVDF as the only single binder.

Table 1 compares multiple anode compositions that underwent heat treatment to 330° C. with the compositions containing only single binders.

| | Anode composition | | | | | | Full cell electrochemical data | | |
|---|---|---|---|---|---|---|---|---|---|
| Example | Silicon Material % | PAN % | PVDF % | Conductive Carbon % | Oxalic Acid % | First Cycle Eff% | capacity mAh/cm² | Anode Capacity mAh/g | % cathode capacity |
| MD-B1 | 80.00 | 16.5 | 1.0 | 2.4 | 0.1 | 77.55 | 3.77 | 1447.9 | 92 (=3.77/4.1) |
| MD-B2 | 87.75 | 7.05 | 2.7 | 2.4 | 0.1 | 62.93 | 2.78 | 1347.6 | 24.4 |
| MD-B3 | 90.00 | 16.5 | 1.0 | 2.4 | 0.1 | 72.87 | 3.48 | 1180.3 | 84.9 |
| MD-B4 | 87.75 | 12.8 | 1.0 | 2.4 | 0.1 | 74.92 | 3.73 | 1353.7 | 91.0 |
| MD-B5 | 80.00 | 12.5 | 5.0 | 2.4 | 0.1 | 78.3 | 3.8 | 1837.9 | 93 |
| MD-B6 | 87.75 | 7.8 | 1.95 | 2.4 | 0.1 | 74.87 | 3.68 | 1258.4 | 89.8 |
| MD-B7 | 82.75 | 10.8 | 3.95 | 2.4 | 0.1 | 73.46 | 3.46 | 1304.9 | 84.4 |
| MD-B8 | 86.50 | 7.05 | 3.95 | 2.4 | 0.1 | 71 | 3.25 | 1294.6 | 79.3 |
| MD-B9 | 90.00 | 5.0 | 2.5 | 2.4 | 0.1 | 67.89 | 3.05 | 1371.1 | 74.4 |
| MD-B10 | 85.50 | 9.1 | 2.9 | 2.4 | 0.1 | 75.26 | 3.64 | 1332.0 | 88.8 |
| MD-B11 | 87.50 | 5.0 | 5.0 | 2.4 | 0.1 | 65.57 | 2.9 | 1402.9 | 70.7 |
| CA-B25 | 87.50 | 0 | 10 | 2.4 | 0.1 | 21.1 | 0.67 | 400 | 16.3 |
| B169 | 78 | 19.5 | 0 | 2.4 | 0.1 | 78.4 | 3.82 | 1370 | 93 |

### Example 2

Silicon composite material was mixed with 150,000 MW (150 K) PAN polymer binder by ball milling the solids at low rpm. Anhydrous NMP was used as solvent to disperse PVDF using centrifugal mixing before adding the silicon/PAN solid mixture to the dispersion. The slurry was mixed overnight, and a benchtop doctor-blade coater was used to slurry the slurry on to copper current collectors to get electrodes with > 3.5 mg/cm² solid loadings. The electrodes were dried at 60° C. to remove NMP solvent. Then the electrodes were heat treated in an inert argon atmosphere at 330° C.

Accordingly, via a roll-to-roll anode coating process, we can engineer the surface chemistry of silicon materials. Cyclized PAN polymer binder driven coating imparts its mechanical strength, electrical conductivity, and chemical stability to Silicon, addressing the major challenges.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

I/we claim:

1. An anode configured for use in an electrochemical energy storage device, the anode comprising:
a plurality of active material particles;
a first cyclized polymer binder; and
a second polymer binder, wherein the first polymer binder is a different type of polymer binder from the first polymer binder.

2. The anode of claim 1, wherein the first cyclized polymer binder is cyclized polyacrylonitrile (PAN).

3. The anode of claim 1, wherein the second polymer binder is poly(vinylidene fluoride) (PVDF).

4. The anode of claim 1, wherein the ratio of first cyclized polymer binder to second polymer binder in the anode is from about 1:1 to about 4:1.

5. The anode of claim 1, wherein the anode comprises from about 5 wt. % to about 30 wt. % of the first cyclized polymer binder and from about 1 wt. % to about 20 wt. % of the second polymer binder.

6. The anode of claim 1, further comprising a third polymer binder.

7. The anode of claim 1, wherein the active material particles comprise silicon particles and graphite particles.

8. The anode of claim 7, wherein the active silicon particles comprise bare silicon particles.

9. The anode of claim 7, wherein the silicon particles comprise Si-composite particles.

10. The anode of claim 9, wherein the Si-composite particles comprise silicon-carbon composite materials, silicon oxide particles or silicon metal alloy.

11. The anode of claim 1, wherein each of the plurality of active material particles have a particle size in a range of from about 1 nm to about 100 µm.

12. The anode of claim 1, further comprising conductive carbon nanoparticles present in the anode in a range of from about 0.1 wt. % to about 5 wt. %.

13. The anode of claim 12, wherein the conductive carbon nanoparticles comprise vapor grown carbon fibers (VGCF), carbon black, carbon nanotubes or mixture thereof.

14. The anode of claim 1, further comprising an acid binder in the anode in a range of from about 0.01 wt. % to about 2 wt. %.

15. The anode of claim 14, wherein the acid binder comprises oxalic acid, citric acid, maleic acid, tartaric acid, 1,2,3,4-butanetetracarboxylic acid or mixture thereof.

16. An electrochemical energy storage device comprising:
an anode comprising:
a plurality of active material particles,
a first cyclized polymer binder, and
a second polymer binder, wherein the first polymer binder is a different type of polymer binder from the second polymer binder;
a cathode; and
an electrolyte including at least one lithium salt.

17. The device of claim 16, wherein the first polymer binder is cyclized polyacrylonitrile (PAN).

18. The device of claim 16, wherein the second polymer binder is poly(vinylidene fluoride) (PVDF).

19. The device of claim 16, wherein the ratio of first cyclized polymer binder to second polymer binder in the anode is from about 1:1 to about 4:1.

20. The device of claim 16, wherein the anode comprises from about 5 to about 30 wt. % of the first cyclized polymer binder and from about 1 to about 20 wt. % of the second polymer binder.

21. The device of claim 16, further comprising a third polymer binder.

22. The device of claim 16, wherein the active material particles comprise silicon particles and graphite particles.

23. The device of claim 22, wherein the silicon particles comprise bare silicon particles.

24. The device of claim 22, wherein the silicon particles comprise Si-composite particles.

25. The device of claim 24, wherein the Si-composite particles comprise silicon-carbon composite materials, silicon oxide particles or silicon metal alloy.

26. The device of claim 16, wherein each of the plurality of active material particles has a particle size in the range of from about 1 nm to about 100 µm.

27. The device of claim 16, wherein the cathode comprises a lithium metal oxide, spinel, olivine, carbon-coated olivine, vanadium oxide, lithium peroxide, sulfur, polysulfide, a lithium carbon monofluoride or mixture thereof.

28. The device of claim 16, wherein the cathode is a transition metal oxide material and comprises an over-lithiated oxide material.

29. The device of claim 16, further comprising a porous separator separating the anode and the cathode from each other.

30. A method of making an anode for use in an electrochemical energy storage device, the method comprising:
b) mixing together a plurality of active material particles, a first polymer binder that undergoes a cyclization reaction when heated and a second polymer binder to form a mixture;
c) coating the mixture onto a current collector to form a coated current collector; and
d) subjecting the coated current collector to a temperature treatment.

31. The method of claim 30, wherein subjecting the coated current collector to the temperature treatment comprises heating the coated current collector in an inert atmosphere to a temperature in a range of from about 200° C. to about 600° C.

32. The method of claim 30, wherein the coated current collector is heated to a temperature in a range of from about 240° C. to about 400° C.

33. The method of claim 30, further comprising:
after step a) and before step b), adding a solvent to the mixture to disperse the active material particles, the first polymer binder and the second polymer binder, the solvent being selected from the group consisting of N-methyl-2-pyrrolidone (NMP), N,N-dimethylformamide (DMF), dimethyl sulfone (DMSO₂), dimethyl sulfoxide (DMSO), ethylene carbonate (EC), and propylene carbonate (PC).

34. The method of claim 33, further comprising:
after step b) and prior to step c), removing the solvent from the mixture coated on the current collector.

35. The method of claim 30, wherein step c) removes the solvent from the mixture coated on the current collector.

36. The method of claim 30, wherein the size of the active material particles ranges from about 1 nm to about 100 µm.

37. The method of claim 30, wherein the mixture formed in step a) comprises from 30 % to 90 % by weight active material particles.

38. The method of claim 30, wherein the mixture formed in step a) comprises from 5 % to 40 % by weight of the first polymer binder and second polymer binder.

39. The method of claim 30, wherein the first polymer binder is polyacrylonitrile (PAN).

40. The method of claim 30, wherein the second polymer binder is poly(vinylidene fluoride) (PVDF).

41. The method of claim 30, wherein the ratio of first polymer binder to second polymer binder in the mixture is from about 1:1 to about 4:1.

42. The method of claim 30, wherein the mixture comprises from about 5 wt. % to about 30 wt. % of the first polymer binder and from about 1 wt. % to about 20 wt. % of the second polymer binder.

43. The method of claim 30, further comprising adding a third polymer binder to form the mixture.

44. The method of claim 30, wherein the active material particles comprise silicon particles and graphite particles.

45. The method of claim 44, wherein the silicon particles comprise bare silicon particles.

46. The method of claim 44, wherein the silicon particles comprise Si-composite particles.

47. The method of claim 46, wherein the Si-composite particles comprise silicon-carbon composite materials, silicon oxide particles or silicon metal alloy.
